(19) United States
(12) Patent Application Publication
(10) Pub. No.: US 2014/0114870 A1
(43) Pub. Date: Apr. 24, 2014

(54) SYSTEM AND METHOD FOR ONLINE CAREER DEVELOPMENT

(71) Applicant: UCMETALK, INC., Irvine, CA (US)

(72) Inventor: Mohammad Nazir Arabi Katbi, Irvine, CA (US)

(73) Assignee: UCME Talk, Inc., Irvine, CA (US)

(21) Appl. No.: 13/843,969

(22) Filed: Mar. 15, 2013

Related U.S. Application Data
(60) Provisional application No. 61/717,040, filed on Oct. 22, 2012.

(51) Int. Cl. G06Q 10/10

(52) U.S. Cl. CPC G06Q 10/1053
USPC 705/321

(57) ABSTRACT

Systems and methods of online career development are described. According to one embodiment, an online career fair is provided where companies can conduct interviews with applicants, such as students, online. For example, companies can host round-robin style video interviews with applicants. Applicants will be able to log in to a host website with a time ticket and interview with companies immediately, or queue up in a line to wait for an interview slot. These interviews may be full interviews, or quick, one-the-go style interviews. Companies have access to the applicants they want, for example, from the universities they choose and the GPAs they mandate. After a preregistration and preapproval process, the career fair launches for a designated time, giving companies and applicants ample opportunity to conduct interviews

### PRIORITY CLAIM

This application claims the benefit of provisional patent application serial No. 61/717,040 filed Oct. 22, 2012, titled “Online Career Development Platform”, the contents which are incorporated herein by reference in their entirety.

### FIELD

The present disclosure relates generally to career development, and more particularly, to systems and methods for online career development.

### BACKGROUND

Career development for students is important. Since most students these days are “connected” and have access to numerous Internet and other network resources and communication channels, and also can store their own background information and qualifications electronically for ready access, it would be beneficial for them to be able to interface with potential employers for exchanging information and feedback bidirectionally with potential employers and other career professionals, streamlining the job search and placement process.

### SUMMARY

According to one embodiment, an online career fair is provided where companies can conduct interviews with applicants, such as students, online. For example, companies can host round-robin style video interviews with applicants. Applicants will be able to log in to a host website with a time ticket and interview with companies immediately, or queue up in a line to wait for an interview slot. These interviews may be full interviews, or quick, one-the-go style interviews. Companies have access to the applicants they want, for example, from the universities they choose and the GPAs they mandate. After a preregistration and preapproval process, the career fair launches for a designated time, giving companies and applicants ample opportunity to conduct interviews.

According to one embodiment, a method for online career development is described. The method comprises receiving applications, preapproving the applications, selecting applicants for interviews based on the applications, hosting a groundbreaking session with the selected applicants, hosting the interviews with the selected applicants, and aggregating results of the interviews. According to another embodiment, a computer readable medium having computer executable instructions embedded thereon for performing the acts of this method is described. Systems for effects this method are also described herein.

It should be noted that the method and system herein are not restricted to a single university or institution, but that other such institutions can be involved, in a network of universities for example.

### BRIEF DESCRIPTION OF THE DRAWINGS

FIG. 1 is a flowchart illustrating a method for online career development according to an embodiment.

FIG. 2 is a schematic diagram illustrating a system of an embodiment for effecting the methods described herein.

FIG. 3 is diagrammatic representation of a machine having a set of instructions for causing the machine to perform any of the one or more methods described herein.

### DETAILED DESCRIPTION

Systems and methods for online career development are described. In the following description, for purposes of explanation, numerous specific details are set forth in order to provide a thorough understanding of the exemplary embodiments. It is apparent to one skilled in the art, however, that embodiments can be practiced without these specific details or with an equivalent arrangement. In some instances, well-known structures and devices are shown in block diagram form in order to avoid unnecessarily obscuring the embodiments.

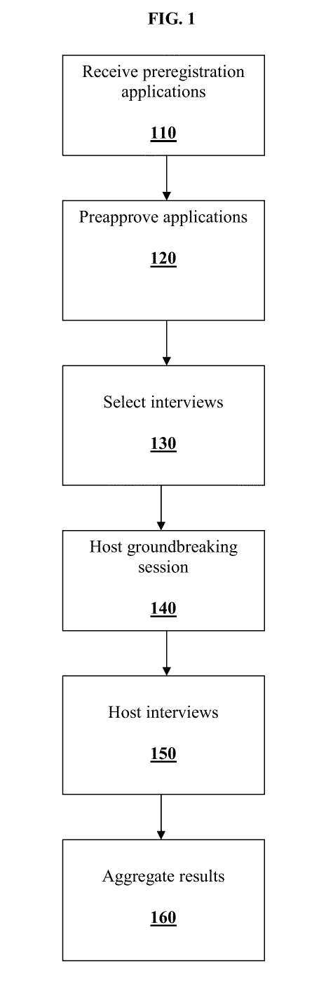

Referring now to the drawings, wherein like reference numerals designate identical or corresponding parts throughout the several views, FIG. 1 is a flowchart illustrating a method for online career development via a career fair according to one embodiment. At processing block 110, preregistration applications are received. Prior to the career fair, applicants, such as students, are able to preregister online through a host career fair page. Applicants can submit their resumes, GPAs, declared major(s), university classification, and university name. Optionally, applicants can also select which companies attending the career fair that they would like to interview with. At processing block 120, applications are selectively preapproved.

At processing block 130, interviews are selected. Applicants can select certain time slots available to them in order to determine their time ticket and when they would like to interview with companies. This decides the order of the interviews for the convenience of the company as well as the applicants. Once applicants have selected their time slots and generated their time tickets, they are ready to log in on career fair day and interview with the companies in attendance.

At processing block 140, a groundbreaking session is hosted for the applicants and companies. Prior to the career fair, applicants and companies can log in to a host website and casually video chat with one another in a controlled environment. Company representatives are paired up with applicants through a video medium, allowing them to get to know each other prior to the professional interview. The groundbreaking session allows companies and applicants to meet one another informally. In addition, it allows companies to isolate and select students who have made an impression on them prior to the formal interview.

At processing block 150, interviews at the online career fair are hosted for the applicants and companies. The career fair spans for an allotted time after the groundbreaking session is complete. The career fair is a virtual portal where all of the companies that have registered with the host service or website can be accessed by applicants that have also registered and have logged in via their time ticket. At this point, many applicants will have already selected what time they want to conduct interviews with certain companies, thus allowing them to begin the interview process at their prescribed time rather than waiting in a queue. Applicants who did not register for specific interview times can wait in a virtual queue. Once a company has finished all of their time-ticketed interviews, it can interview applicants in the virtual queue.

At processing block 160, results are aggregated. Upon completion of an interview, applicants can rate the interviewer as a way of giving feedback to the company. Additionally, the company can rate the applicant on a set of preordained criteria provided by the host service or website and can catalog the applicant in a virtual file. This catalog of applicants and interviewers can then be referenced later by applicants and interviewers alike. After the interviews have been conducted, the feedback submitted and the catalog archived, applicants can check their status on the host website to determine whether the company would like to interview them again, whether the company would like to hire them, etc. The company representative can categorize a student based on performance and decide if they want to interview that person again via the host service or website, hire that person, or take the interview to another level outside of the host service or website.

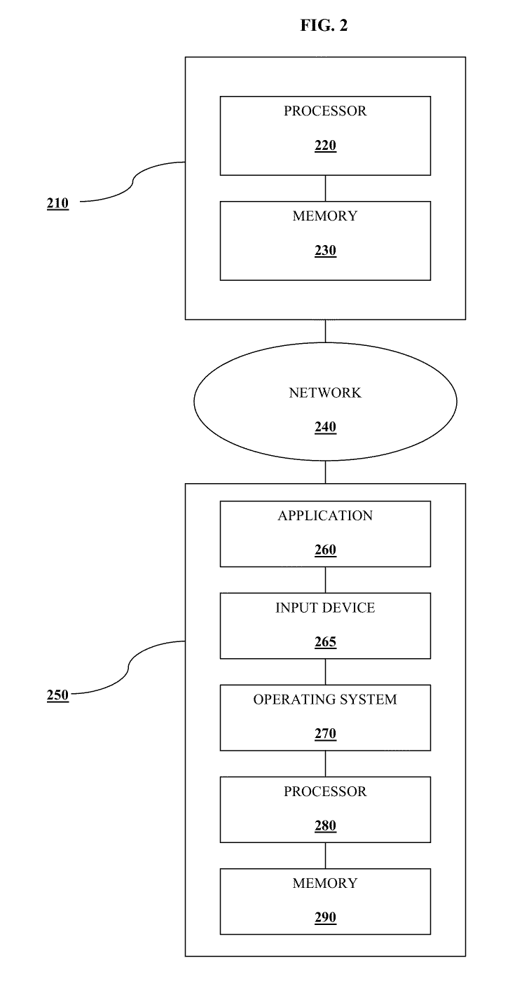

FIG. 2 illustrates a system for effecting the acts of one or more of the methodologies described herein. Server 210 is connected over network 240 to a user device 250. Server 210 includes processor 220 and memory 230, which are in communication with one another. Server 210 is typically a computer system, and may be an HTTP (Hypertext Transfer Protocol) server, such as an Apache server. It is contemplated, however, that server 210 can be a single or multiple modules or devices hosting downloadable content or portions thereof. Further, server 210 can be a dedicated server, a shared server, or combinations thereof. For example, server 210 can be a server associated with the developer, publisher or distributor of the application 260, or a third-party server, such as a peer device in a peer-to-peer (P2P) network. In addition, server 210 can comprise a virtual market or online shopping-based service offering the application 260. In this embodiment, server 210 (alone or in combination with other devices) can process and perform various commercial transactions, such as billing, in addition to those acts described herein.

User device 250 includes application 260, input device 265, operating system 270, processor 280, and memory 290, which are in communication with one another. In one embodiment, user device 250 is a game console. In that embodiment, application 260 may be a game, and input device 265 may be a controller. Server 210 and user device 250 are characterized in that they are capable of being connected to network 240. Network 240 can be wired or wireless, and can include a local area network (LAN), wide area network (WAN), a telephone network (such as the Public Switched Telephone Network (PSTN)), a radio network, a cellular or mobile phone network (such as GSM, GPRS, CDMA, EV-CO, EDGE, 3GSM, DECT, IS-136/TDA, iDEN, and the like), intranet, the Internet, or combinations thereof. Memory 230 and memory 290 may be any type of storage media that may be volatile or non-volatile memory that includes, for example, read-only memory (ROM), random access memory (RAM), magnetic disk storage media, optical storage media, flash memory devices, zip drives, and combinations thereof. Memory 230 and memory 290 can be capable of permanent or temporary storage, or both; and can be internal, external, or both.

In use, application 260 makes calls to operating system 270 to load and access data stored in memory 290, using standard file operations. Application 260 can be any software and/or hardware that provides an interface between a user of user device 250 (via input device 265) and operating system 270. The standard file operations include, for example, “open” (i.e., specifying which file is to be accessed), “seek” (i.e., specifying what position to go to in the file to read data), “read” (i.e., requesting that data be read from the file and copied to application 260), and “close” (i.e., requesting that the file be closed for now).

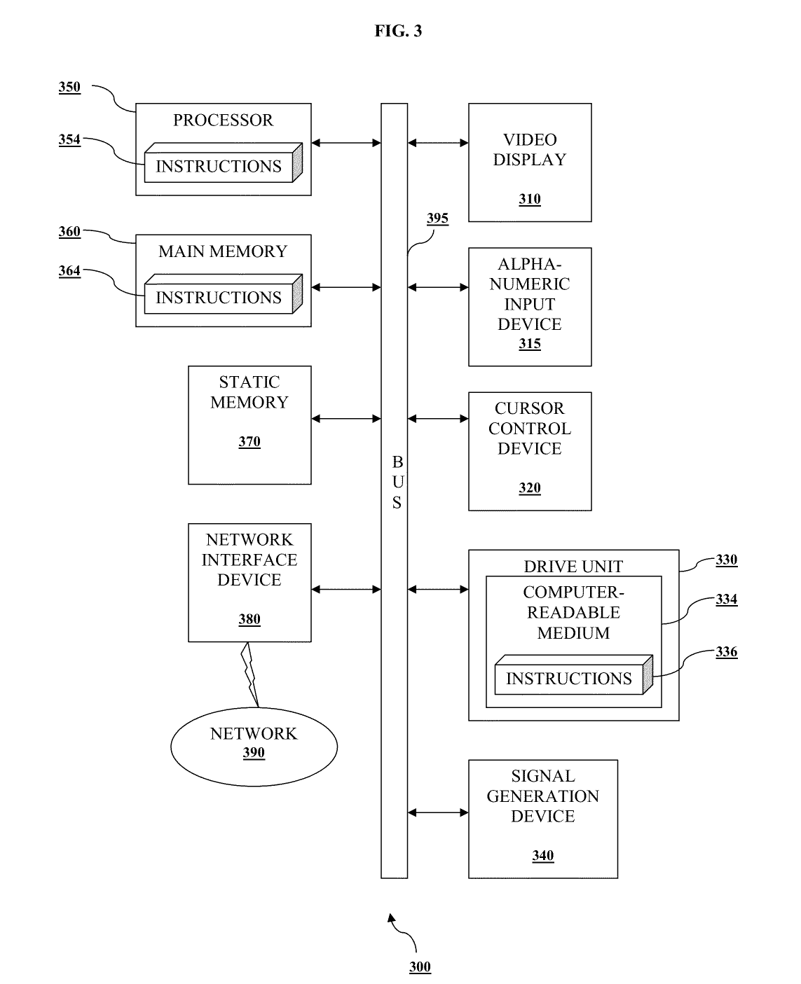

FIG. 3 shows a diagrammatic representation of machine in the exemplary form of computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, as a host machine, or as a peer machine in a peer-to-peer (or distributed) network environment. The machine may be a personal computer (PC), a tablet, a set-top box (STB), a Personal Digital Assistant (PDA), a cellular telephone, a web appliance, a network router, switch or bridge, a game console, a television, a CD player, a DVD player, a BD player, an e-reader, or any machine capable of executing a set of instructions (sequential or otherwise) that specify actions to be taken by that machine. Further, while only a single machine is illustrated, the term “machine” shall also be taken to include any collection of machines or modules that individually or jointly execute a set (or multiple sets) of instructions to perform any one or more of the methodologies discussed herein.

According to some embodiments, computer system 300 comprises processor 350 (e.g., a central processing unit (CPU), a graphics processing unit (GPU) or both), main memory 360 (e.g., read only memory (ROM), flash memory, dynamic random access memory (DRAM) such as synchronous DRAM (SDRAM) or Rambus DRAM (RDRAM), etc.) and/or static memory 370 (e.g., flash memory, static random access memory (SRAM), etc.), which communicate with each other via bus 395.

According to some embodiments, computer system 300 may further comprise video display unit 310 (e.g., a liquid crystal display (LCD), a light-emitting diode display (LED), an electroluminescent display (ELD), plasma display panels (PDP), an organic light-emitting diode display (OLED), a surface-conduction electron-emitted display (SED), a nanocrystal display, a 3D display, or a cathode ray tube (CRT)). According to some embodiments, computer system 300 also may comprise alphanumeric input device 315 (e.g., a keyboard), cursor control device 320 (e.g., a controller or mouse), disk drive unit 330, signal generation device 340 (e.g., a speaker), and/or network interface device 380.

Disk drive unit 330 includes computer-readable medium 334 on which is stored one or more sets of instructions (e.g., software 336) embodying any one or more of the methodologies or functions described herein. Software 336 may also reside, completely or at least partially, within main memory 360 and/or within processor 350 during execution thereof by computer system 300, main memory 360 and processor 350. Processor 350 and main memory 360 can also constitute computer-readable media having instructions 354 and 364, respectively. Software 336 may further be transmitted or received over network 390 via network interface device 380.

While computer-readable medium 334 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the disclosed embodiments. The term “computer-readable medium” shall accordingly be taken to include, but not be limited to, solid-state memories, and optical and magnetic media.

It should be understood that processes and techniques described herein are not inherently related to any particular apparatus and may be implemented by any suitable combination of components. Further, various types of general purpose devices may be used in accordance with the teachings described herein. It may also prove advantageous to construct a specialized apparatus to perform the methods described herein. Those skilled in the art will appreciate that many different combinations of hardware, software, and firmware will be suitable for practicing the disclosed embodiments.

Embodiments have been described in relation to particular examples, which are intended in all respects to be illustrative rather than restrictive. Further, while embodiments have been described in connection with a number of examples and implementations, it is understood that various modifications and equivalent arrangements can be made to the examples while remaining within the scope of the inventive embodiments.

Other embodiments will be apparent to those skilled in the art from consideration of the specification and practice of the embodiments disclosed herein. Various aspects and/or components of the described embodiments may be used singly or in any combination. It is intended that the specification and examples be considered as exemplary only, with a true scope and spirit of the disclosure being indicated by the following claims.

What is claimed is:

1. A method for online career development, the method comprising:
receiving applications;
preapproving the applications;
selecting applicants for interviews based on the applications;
hosting a groundbreaking session with the selected applicants;
hosting the interviews with the selected applicants; and
aggregating results of the interviews.

2. The method of claim 1, wherein the applicants are students.

3. The method of claim 1, wherein the applications comprise one or more of resumes, GPAs, declared major(s), university classifications and university names.

4. The method of claim 1, wherein the applications comprise selections of companies.

5. The method of claim 1, further comprising:
assigning selected applicants a time slot.

6. The method of claim 1, further comprising:
generating a queue of selected applicants.

7. The method of claim 1, wherein the results comprise at least one of interviewer feedback and selected applicant feedback.

8. The method of claim 1, further comprising:
publishing results of the interviews.

9. A system for online career development, the system comprising:
a processor operable to:
receive applications,
preapprove the applications,
select applicants for interviews based on the applications,
host a groundbreaking session with the selected applicants, and
host the interviews with the selected applicants,
a memory operable to store results of the interviews.

10. The system of claim 9, wherein the applicants are students.

11. The system of claim 9, wherein the applications comprise one or more of resumes, GPAs, declared major(s), university classifications and university names.

12. The system of claim 9, wherein the applications comprise selections of companies.

13. The system of claim 9, wherein the processor is further operable to:
assign selected applicants a time slot.

14. The system of claim 9, wherein the processor is further operable to:
generate a queue of selected applicants.

15. The system of claim 9, wherein the results comprise at least one of interviewer feedback and selected applicant feedback.

16. The system of claim 9, wherein the processor is further operable to:
publish results of the interviews.

17. A computer readable medium having computer executable instructions embedded thereon for performing the steps of:
receiving applications;
preapproving the applications;
selecting applicants for interviews based on the applications;
hosting a groundbreaking session with the selected applicants;
hosting the interviews with the selected applicants; and
aggregating results of the interviews.

18. The computer readable medium of claim 17, wherein the applicants are students.

19. The computer readable medium of claim 17, wherein the applications comprise one or more of resumes, GPAs, declared major(s), university classifications and university names.

20. The computer readable medium of claim 17, wherein the applications comprise selections of companies.

21. The computer readable medium of claim 17, wherein the steps further comprise:
assigning selected applicants a time slot.

22. The computer readable medium of claim 17, wherein the steps further comprise:
generating a queue of selected applicants.

23. The computer readable medium of claim 17, wherein the results comprise at least one of interviewer feedback and selected applicant feedback.

24. The computer readable medium of claim 17, wherein the steps further comprise:
publishing results of the interviews.
